(19) United States
(12) Patent Application Publication
(10) Pub. No.: US 2015/0046274 A1
(43) Pub. Date: Feb. 12, 2015

(54) GRATUITY PROCESSING SYSTEM APPARATUS AND RELATED METHODS

(71) Applicant: ANDREW M. PHILLIPS, Costa Mesa, CA (US)

(72) Inventor: ANDREW M. PHILLIPS, Costa Mesa, CA (US)

(21) Appl. No.: 14/530,475

(22) Filed: Oct. 31, 2014

Related U.S. Application Data
(63) Continuation of application No. 14/281,763, filed on May 19, 2014.
(60) Provisional application No. 61/611,123, filed on Mar. 15, 2012.

(51) Int. Cl. G06Q 40/00; G06Q 20/20; G06Q 20/10; G06Q 20/34

(52) U.S. Cl. CPC G06Q 40/125; G06Q 20/349; G06Q 20/20; G06Q 20/10
USPC 705/16

(57) ABSTRACT

Apparatus and methods are disclosed to improve the administration of tip monitoring, collection, and distribution, and related reporting needs (such as for U.S. tax reporting). POS systems and employee prepaid debit cards can be used to make the distribution process “cash-less.”

### CROSS-REFERENCE TO RELATED APPLICATIONS

This application claims priority to U.S. application Ser. No. 14/281,763, filed May 19, 2014, which claimed priority to PCT Application Ser. No. PCT/US2013/032061, filed on Mar. 15, 2013, which claimed priority to U.S. Provisional Application Ser. No. 61/611,123, filed Mar. 15, 2012, the disclosures of which are incorporated herein by reference in their entirety.

### BACKGROUND OF INVENTION

The present invention is described herein with reference to the accompanying Figures, which serve as illustrations of some of the many embodiments in which the invention may be practiced. Subject to the context and other factors (including for example the understanding of persons of ordinary skill in the arts relevant to the inventions), generally in those Figures and references similar reference numerals refer to similar or identical elements throughout this description.

Those Figures and references, and the other terminology used in these descriptions, are not intended to be interpreted in any limited or restrictive manner, simply because it is being utilized in conjunction with a detailed description of certain embodiments of the invention. Furthermore, various embodiments of the invention (whether or not specifically described herein) may include one or more of the novel features disclosed herein, no single one of which (a) is necessarily solely responsible for any particular desirable attribute(s) of the inventions or (b) is essential to practicing the inventions described.

Although the disclosed inventions may provide many benefits and be useful in a broad range of applications, they are particularly useful in situations involving employees who receive tips from customers. Among other things, the apparatus and methods of the disclosed inventions preferably are designed to streamline the disbursement process for service establishments that regularly pay gratuities to employees. This includes, by way of example and not by way of limitation, industries such as full-service restaurants, casinos, hair salons, hotels, and others. As explained herein, the inventions help such businesses by simplifying and helping them better manage their cash flow, reconciliation, and reporting of gratuities earned by their service staff.

Various embodiments of the invention provide benefits for both the employer and the employee. For example, the invention can provide to employers some or all of the following benefits:
Streamlined tip disbursement process
Greater tip reconciliation and tracking ability
Easy-to-use reporting functions and transaction history detail
Reduced cash burden and leakage (money that has been spent/disbursed but there is no record of where/how it was spent/disbursed)
Greater control of tip processing, from start to finish
Workflow management tied to user related hierarchy sign-offs allowing employers to control who within the organization can move funds and at what thresholds or velocities they can move funds—either between funding accounts or to employees receiving tips
Better employee experience (see below for some of the reasons), resulting in greater retention of labor assets

Embodiments of the invention also can provide to employees some or all of the following benefits:
A powerful, cost-effective financial tool
Easy-to-use reporting functions and transaction history details
A better, safer solution than being paid their tips in cash, including reducing the risk of theft
The ability to receive their tips without being present at the restaurant or other location. For example, this means that employees no longer have to hang around after their shift, waiting for the tip calculations/disbursement process
Better overall financial experience from employer (for example, employers no longer need to bring cash in to tip-out employees either via armored car or employee time to go the bank for cash).
Employers no longer need to pay someone to reconcile and manually pay tips to employees.
Employers no longer have employees standing around on company time waiting for their tips to be paid.

Said another way, and as described below and in the accompanying Figures, various embodiments of the invention provide one or more of the following functions and/or benefits:
simplify and help ensure compliance with tax reporting and/or other legal requirements related to tip income, for both employers and tipped employees
eliminate the use of cash for distributing tips and tip-outs at the end of a workshift
provide employees with instant access to their tip money, upon completion of their workshift
improve workforce safety—the employees are not carrying those tips in the form of cash
enable more precise tip workflow management
provide comprehensive tracking and reporting of tip activities and results
dramatically reduce cash management requirements and related costs
simplifies reconciliation related to cash tip distributions
reduces cash losses from miscounting or other human error (or malfeasance)

Preferred embodiments of the inventions provide a seamless experience between an employer, its employees, and any intermediate System/Processor 10 (see FIG. 1 and related discussion below). Preferably, user interfaces on any computer screen (whether for employer or employee) are easy to use and effective, so that the system will be readily adopted and used, across whole businesses and/or even entire industries. The systems of the invention preferably balance the user experience and cost effective development/customization for each business, to optimize the business's tip-management activities and efforts. Depending on budgets, technology advances, and other factors, the apparatus and processes of the inventions discussed herein can have virtually unlimited capacity, but can also be practiced on a more cost-conscious basis by careful selection of appropriate hardware and software and communication capabilities.

### BRIEF DESCRIPTION OF THE DRAWINGS

FIGS. 1, 2a, and 2b are flow charts that represent a preferred embodiment of some of the systems and methods of the present inventions. Among other things, these illustrate some of the many ways that the invention can be used to automate the tip pay-out process between Point-of-Service/Sale (POS) systems 20 (commonly used in restaurants and other businesses whose employees receive tips) and employees/staff who interact with the POS 20. As illustrated, the inventions enable payment of tips to those employees/staff, without using cash.

FIG. 1 illustrates a basic structure/system, with one or more venues 15 (restaurants/other businesses) shown on the left, each using multiple POS systems 20. In this embodiment, throughout the work shift, the tip information is input in real-time at the POS 20 (by the employee, cashier, or some other designated person). In this preferred system, each employee who will receive tips also has their own employer-issued prepaid debit card 5 in their possession or control at all times. For clarity in explaining one of the systems of the invention, those cards 5 are shown on the right side of FIG. 1. Persons of ordinary skill in the art will understand that, in common practice, those cards 5 may actually be in the possession (and even on the person) of the particular employee to whom they have been issued, even while that employee may be inputting tip and other data into the POS 20 during their work shift. In other words, the employee and/or their card does not need to be physically present in order to receive tip payments since they are stored electronically and securely encrypted within the employee's profile in the system.

FIGS. 2a and 2b illustrate one of the many processes for which the system of FIG. 1 can be used. As illustrated in FIG. 2a, at the end of the work shift (or at any other convenient or useful interval), the tip totals 25 or other information/data are uploaded from the POS system(s) 20 to a central processing system 10. As shown in FIG. 2b, upon receipt of that tip data 25, the central processor/system 10 preferably uses that information to either instantly “load” the appropriate tip amounts onto each relevant employee's prepaid debit card 5 (or other similar prepaid/fundable/re-loadable card), or confirm or adjust tip amounts if necessary before being “loaded” onto the card 5. In addition, tip-outs can also be automatically calculated and distributed to other employees at this time depending on location or corporate level business rules set within the system. As indicated above, preferably each employee has their own prepaid debit card 5 in their possession or control at all times, so that this process results in the tip funds 30 being transferred into the employee's possession/control, at the end of the work shift (or any other desired period of time), without the use of hard cash.

FIG. 3 is a chart representing another embodiment and/or aspect of the present inventions. Although a wide variety of other configurations and approaches can be used to practice the invention, FIG. 3 illustrates how the invention can automate at least portions of the back-office administration for funding the tips paid to the employees' prepaid debit cards 5. In FIG. 3, funds that will be used for tips are transferred from a single bank account (labeled “General Business Account” 40) to a “Master (Tip) Funding Account (MFA)” 35. Among other benefits, this approach permits a business to segregate the funds it allocates for tips, and allows the business to keep the funds outside of its General Business Account 40 to a minimum. Depending on various factors (such as the size, structure, location(s), and/or organization of the business), the tip funds can be further segregated and disbursed to each venue 15 (or each property or other metric), as illustrated by the separate location/property Tip Accounts 45 in FIG. 3. Again, simpler approaches (with fewer accounts and transfers, for example) or more complex approaches can be utilized, depending on many factors and the needs and desires of any particular business.

FIGS. 4-12 are representative computer screenshots of one of the many software embodiments with and in which the invention can be practiced. Among other things, these screenshots illustrate some of the invention's preferred capabilities for monitoring, administration, and analytics related to the tip funding, payments, and other aspects of the inventions.

FIG. 4 illustrates one way in which the invention can display the system and some of its information for a corporate manager. Persons of ordinary skill in the art will understand that the information displayed can be customized by assigning privileges/credentials for each user. For example, depending on the user's privileges/credentials, certain data or metrics may be unavailable or presented in a different or limited format. The invention can be customized in this regard (as it can for virtually all aspects and features disclosed herein) for any particular business, to provide multiple hierarchy levels and/or other useful segregation and control of the collected data.

FIG. 5 illustrates one of a wide variety of macro- to micro-detail roll-up and drill-down screens that can be provided as part of the invention. In the screen shown in FIG. 5, the user can select the Shift Session ID for editing and/or display (in the upper portion of the screenshot), and similarly select and/or edit Shift Transactions by selecting a Detail ID (as shown in the lower half of the screenshot). Persons of ordinary skill in the art will understand that this is just one of the many ways in which all tip transactions (or a selected portion of them) can be reviewed, revised, etc.

FIG. 6 illustrates one of the many ways in which the invention preferably enables a business or user to define and implement comprehensive rules-based workflow definitions for their particular cash management processes, goals, etc.

FIG. 7 illustrates yet another process enabled by certain embodiments of the inventions. Employees can enter questions or comments regarding their tips and/or related issues, and the invention can allow not only that input, but also routing, handling, and action/response to the employee's request. The invention preferably enables the responder to easily research information that may be useful in responding, and preserves a record of not just the request but also the resolution of the relevant issue/question.

FIG. 8 illustrates another of the many features and capabilities of the invention. In certain embodiments, the invention can provide helpful workflow management tools, such as for funding requests by a particular venue or group 15 (or other corporate division). Examples of tools include entering special funding requests (increase or decrease from a “normal” amount, for example), organizing and displaying and prioritizing a queue of funding requests, providing a history of such requests, and other capabilities.

FIG. 9 shows an example of some of the customized multi-level organization hierarchies and related information that preferably are included in certain embodiments of the inventions.

FIG. 10 illustrates a preferred messaging functionality that can be included within certain embodiments of the invention. Preferably these embodiments provide secure, rules-based, internal messaging capabilities for the business.

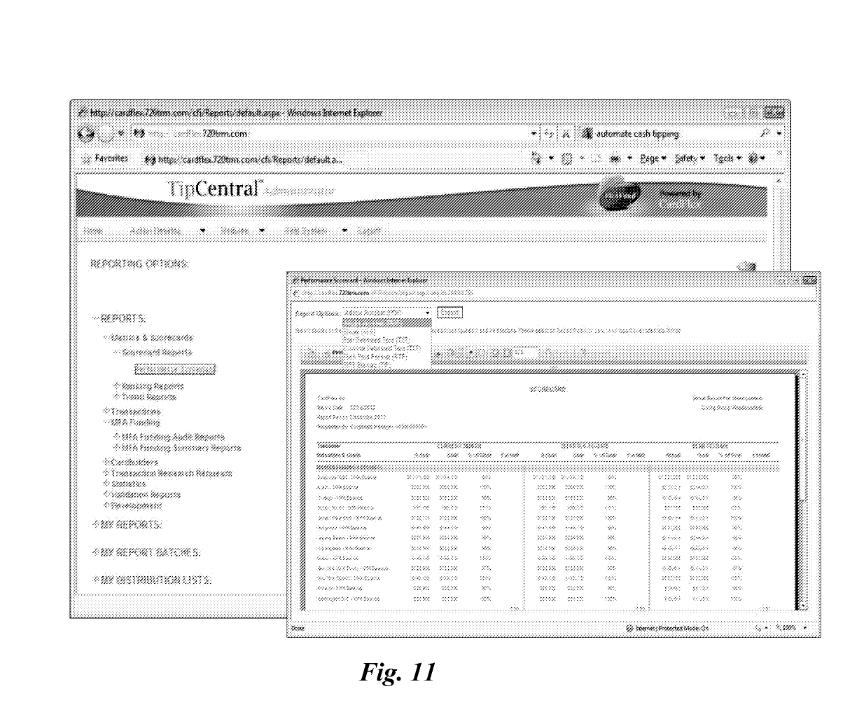

FIG. 11 shows how embodiments of the invention can provide extensive reporting and data extraction functionalities. In addition to allowing easy selection of criteria for data to be included in the report, embodiments can generate reports in separate windows, can export the data into multiple formats, etc., can distribute same via email or otherwise, and can have many other helpful functionalities. Saved/canned custom reports can also be scheduled to run in the future and automatically be distributed to the Message Center for the user to see when they log into the system. In preferred systems, reports can be run at the employee level and rolled up to the corporate level using a customizable hierarchy. For example, systems that utilize the invention preferably can include hierarchies for reporting at levels such as:
Corporate
Division
Region
Location
Venue Type
Employee

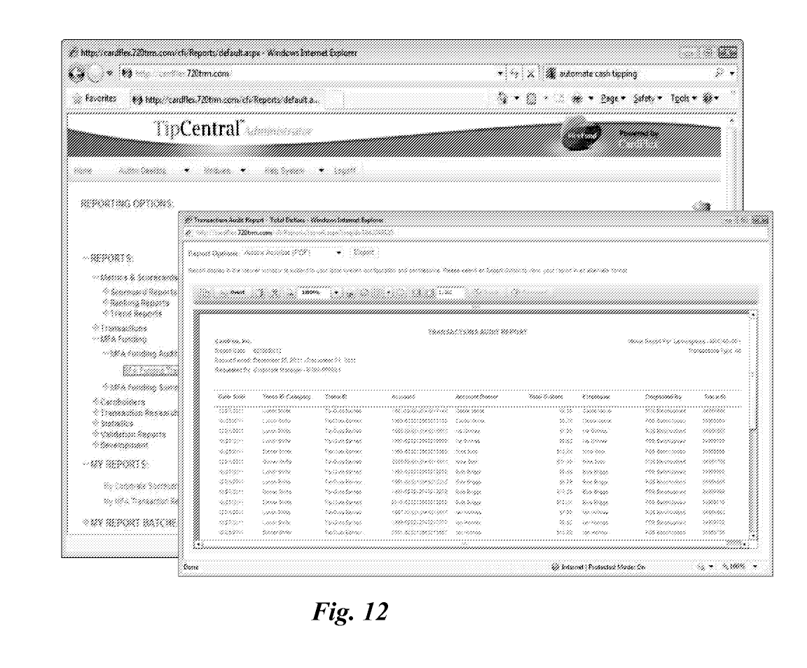

FIG. 12 illustrates the one of the many ways in which the invention can provide summary results down to detail transactions, to enable full reconciliation auditing and other helpful/necessary reports and/or procedures.

### DETAILED DESCRIPTION OF EMBODIMENTS

As indicated above, the inventions disclosed herein can be used in a broad range of applications and provide many benefits. One substantial benefit is in helping companies and their employees/staff comply with U.S. income tax laws regarding “tip” income. Prior to 1988, employees who earned tips already were required to report their tips on their federal tax returns, but there was no corresponding requirement imposed upon their employers. In 1988, the U.S. changed its tax laws: for wait staff and/or other employees who earn at least part of their income in tips, their employer businesses are now required to pay Federal Insurance Contributions Act (FICA) taxes on those tips/gratuities.

Compliance is important, in part because non-compliance can be very costly. The IRS has imposed substantial penalties on companies who did not accurately report and pay those taxes. As a consequence, some restaurants and other companies adopt a “better safe than sorry” approach, and simply over-report their employees' tips. They consider some of these issues and extra costs as part of the cost of doing business. Others avoid at least some of the issues by paying out tips as part of the employees' paychecks.

Preferably, the apparatus and processes of the invention can be customized to virtually any company's needs, and can be readily integrated into the company's current systems. Even though companies' infrastructures and their day-to-day processes and procedures vary widely (even within a given industry), the invention preferably can be easily customized to seamlessly integrate into existing company systems, and to thereby provide very efficient and effective and immediate results. Preferably, the invention uses the same backbone technology that banks use for their own financial systems, transfers, etc.

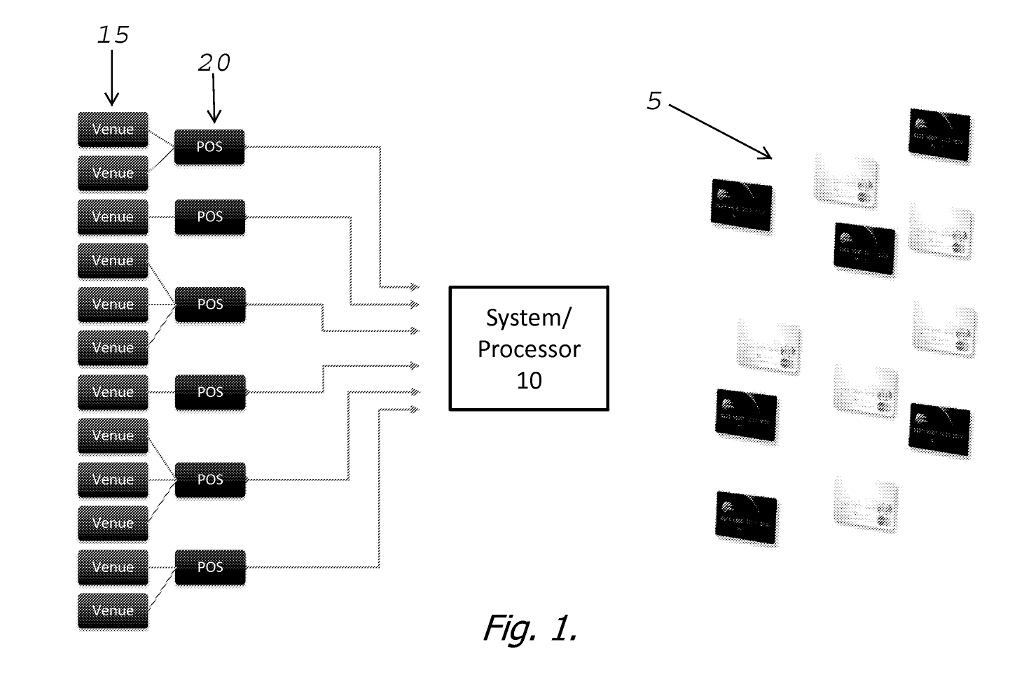

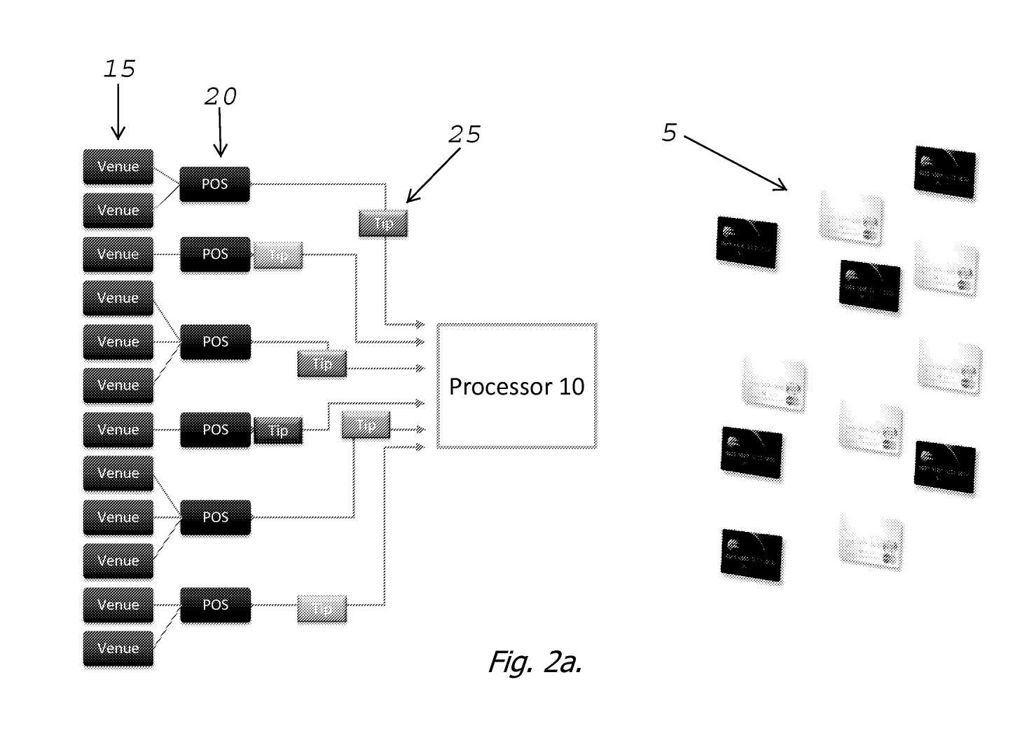

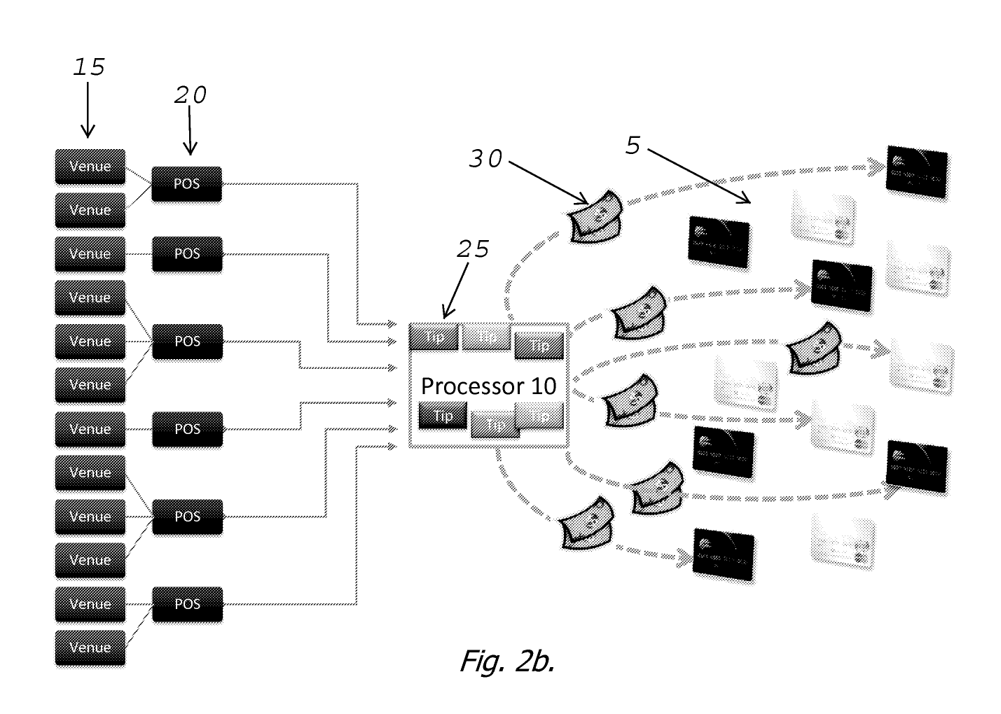

Some examples of how the invention might be implemented are described above, including an example of an end-to-end process described in connection with FIGS. 1-3. Among other things, because some employees prefer to have their tips in their possession at the end of each work shift (rather than waiting to receive those tips as part of their next paycheck), embodiments such as shown in FIGS. 1-3 include the functionality to transfer those tips in real-time electronically to a prepaid debit card 5 that is already in the possession of the employee. Such prepaid debit cards can provide to the employee the safety and security that people expect from a bank card or credit card, but also avoid the stigma that can result from those monies being affected by the employee's actual credit rating, or by being attached to an actual bank account of the employee. Further, once issued to the employee, this prepaid debit card/bank card/etc. 5 can be reloaded/refilled each time the employee works a shift with their earned tips without the employee having to hand-over their card to their manager or swipe their card through a terminal to receive the monies. In other words, once issued and associated with a particular employee, each prepaid debit card 5 can stay within the possession of that employee and be reloaded/refilled with tip monies earned at each shift the employee works.

The invention also can help with more complex “tip” situations. For example, waiters and other servers are often required to share the tips they receive with their support staff (busboys, cooks, dishwashers, etc.). Various embodiments of the invention preferably can handle this “sharing” aspect of tips. In one such approach, when setting up such “sharing” employee within the system software, the employees can be identified as “downstream employees”, “tip-out employees”, or some other appropriate designation. Designating these employees in this manner identifies them as not being a server or employee that gets tips directly, but instead a support employee that is entitled to a share of the server's tips.

More generally, when adding an employee to the tip system, the apparatus and methods of the invention preferably provide options such as those listed here, to a manager or other person setting up the system:
Enter the employee's information (such as their name and employee ID, commonly the same ID that the business uses in other of its systems).
If appropriate, mark the employee as a “downstream” or “tip-Out” employee (or otherwise classify them), and enter their percentage share of the relevant tips and any other relevant information.
Arrange for a prepaid debit card 5 to be given to the employee, to be used for delivery to the employee of their relevant tips. Depending on a number of factors, this can be done by ordering a new personalized card to be delivered to the employee, can be done as part of the inputting process by the person entering the information, or can be accomplished by giving the employee an existing “Instant Issue” prepaid card. An Instant Issue card can be a non-personalized card that an employer can keep on site for new employees or to use in place of lost cards.
Activate the employee's prepaid debit card 5.

The invention preferably allows a similar approach for setting up “shifts” and/or “teams” of employees, which can be useful in tip-sharing calculations and otherwise. For example, in certain embodiments of the invention, the concept of a “shift” can reflect that a given downstream employee or group of such employees may work with several servers throughout a given work day. In certain embodiments, creating a “shift” can involve inputting the following information:
Shift Name
Start date/time and End date/time of the shift
Identifying the employees that will be part of this shift (both servers and downstream employees).

If the restaurant or other business does its tip-sharing within groups within a shift (rather than among all of the employees who work a given shift), the invention preferably includes parameters to input and track sub-groups of the employees, sometimes referred to as “teams” that share tips with other members of their team. For such sub-group or team situations, downstream employees can be assigned to the server(s) with whom they will work and from whom they will receive a share of tips. Preferably, the apparatus and methods of the inventions includes the functionality of assigning a given employee to multiple teams, multiple shifts, and/or other combinations and arrangements.

Proceeding further with such an example, the manager or other person in charge of tip-processing will use the system's software to select the shift or other employee/group for whom they are ready to process tips. Although the system preferably is very flexible in its application and use, a common approach would be to process employee tips at the end of a work shift. Persons of ordinary skill in the art will understand that the invention also can be used to process tips at the end of a work day, or at other custom time period. If the relevant “team” information has not previously been entered, it can be entered at this time (e.g., the server(s) for each team selected, the downstream employees, their respective percentages, etc.). For embodiments in which the employees enter their tip information in real-time at the POS devices 20, the system then uses those parameters to calculate the amount of tips earned for each employee on that team. If instead the tip information is not already available electronically (computer readable) within the system, that information will also have to be input prior to further processing by the system.

Next, the system of the invention preferably calculates the tips owed to each member of each team/group, based on the rules and data that have been input. Certain embodiments can include other steps in these processes, such as providing a step where the tip payments can be adjusted (based on manager or server preference or other factors). At some point, the manager or other person processing the tip payments enters into the software the final instruction to pay out the tips, and the prepaid debit cards 5 for the relevant employees preferably are funded instantly and the balance is available for immediate use by those relevant employees.

Persons of ordinary skill in the art will understand that, without the invention, reconciling cash with tip payouts and receipts can be a time consuming and tedious endeavor. In the case of businesses such as multi-location restaurants, the daily reconciliation can be a full time job in and of itself, to properly monitor, maintain, distribute, and track all of that cash and get the right amount of tips to each employee. By contrast, for embodiments of the invention set up with employee profiles and work shifts setup as described above, the dispersal of tips at the end of a work shift can be as quick as a click of the mouse. In any case, the invention preferably reduces the time and effort required to reconcile its tip records.

The invention preferably reduces the risk of human error in documenting and processing tips and related payments. As mentioned above, for restaurants already using POS systems 20 that track tips, preferred embodiments of the invention can use that data (from the existing POS system 20) within the invention's other functions (e.g., calculating and paying tips, tip-funding, reporting, etc.). In such cases, the invention still preferably identifies the employee and the amount of tips they earned, and calculates the shift and team to which they belong, and calculates the tip amounts that are due to each server and downstream employee. The system of the invention can also be integrated even more directly into the POS system 20, to automatically populate the data into the invention, avoiding the need to enter it manually.

Similarly, the invention preferably provides substantial flexibility in connection with reports using the data that has been collected. Location level access to the invention can be set so as to allow the location manager to view every tip pay out through the system. This information preferably can be “rolled up” in varying displays, allowing a manager to select and display data by groupings ranging from (among others) employee to team, shift, day, or month.

Various embodiments of the invention can provide a wide range of benefits to the employer/business. All tip-related actions, from funding requests to the tip payouts themselves, preferably are logged into the system and therefore can be used in reports and can make reconciliation much easier.

The platform of the invention preferably allows employers to manage, issue, and fund tips onto an employee's prepaid debit card 5 in real time. Embodiments of the invention preferably do one or more of the following:
Calculates downstream or Tip-Out tips when other employees get a share (bus staff, bartenders, etc.).
Tips can be loaded instantly onto the employees' prepaid debit cards 5 and made available for the employees' immediate use (there is no lag time in which those funds are available to the employees; no waiting until the next paycheck, etc. for access to their tips).
No extra cash is required to be on hand for the employer to process tips at the end of a given work shift.
Browser based software application/interface.
Extensive and customizable reporting on the relevant tips, taxes, etc.
Centralized reconciliation; one location or system can reconcile for multiple venues 15.
Companywide tip disbursement reporting, from the employee to the company's CFO or other responsible person.

As indicated above, the invention preferably also provides numerous cash management and other benefits. Among other things, other issues (that are addressed by the invention) include:
Leakage
Employee Theft
Safety: Many restaurants will pay out their tips each night in cash, sending employees out after dark with large amounts of cash in hand.

Some of the foregoing concepts will now be discussed in further detail. In preferred embodiments of the invention, a main menu is displayed on a manager's computer screen, and offers selections to setup staff and shifts, pay tips, upload reports from other systems, perform manual adjustments, and load the funding (MTFA/MFA) account 35. Persons of ordinary skill in the art will understand that other functions can be included, or only some of those listed here, and that the particular interface by which those functions are accessed can be any of a wide range of suitable arrangements and physical interfaces (including keyboard, touchscreen, barcode-scanning, etc.).

Customers are setup as a hierarchy, allowing each level to view detail and summary reporting for everything below them. For example (but not limited to):

```
Corporate
  Division 1
    Region 1.1
      Restaurant 1.1.1
        Employees
      Restaurant 1.1.2
        Employees
    Region 1.2
      Restaurant 1.2.1
        Employees
  Division 2
    Region 2.1
      Restaurant 2.1.1
        Employees
    Region 2.2
      Restaurant 2.2.1
        Employees
      Restaurant 2.2.2
        Employees
      Restaurant 2.2.3
        Employees
```

At levels above restaurant level, system focus is shifted to workflow and reporting, allowing easier organization of the entire business.

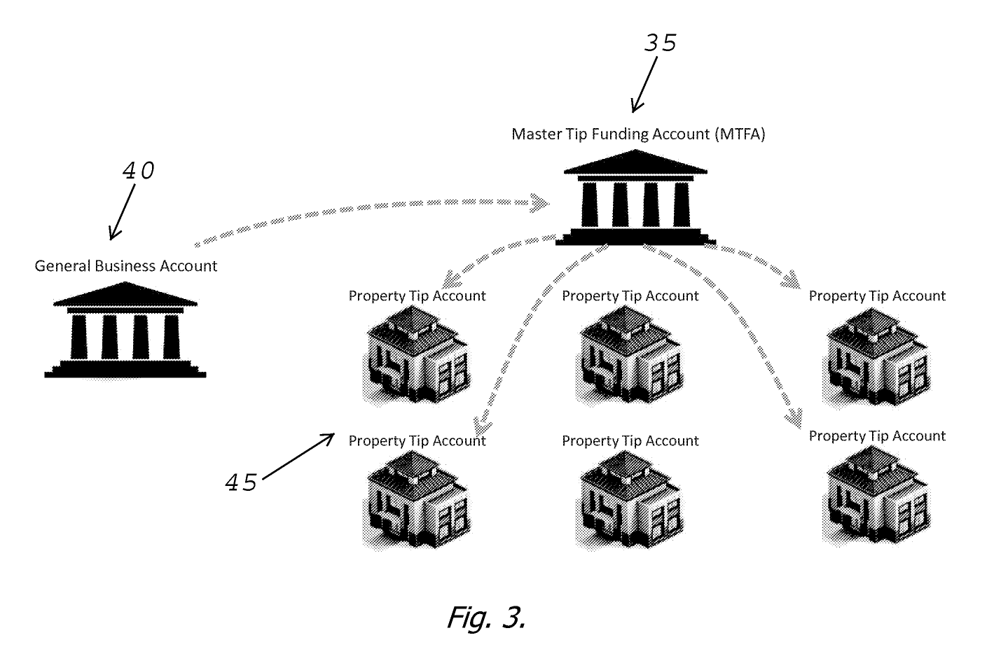

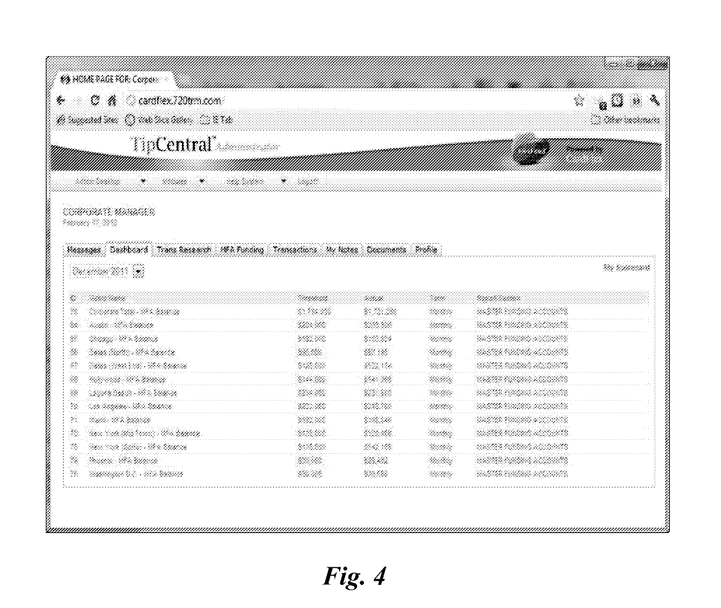

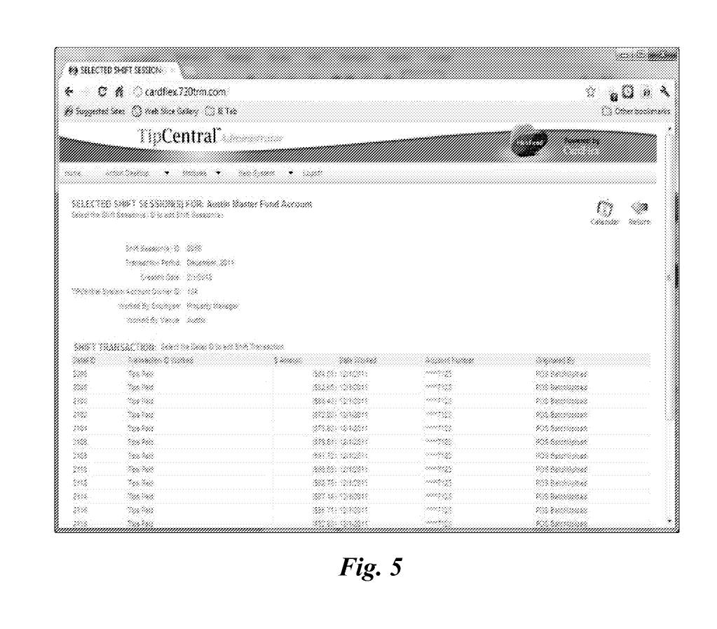

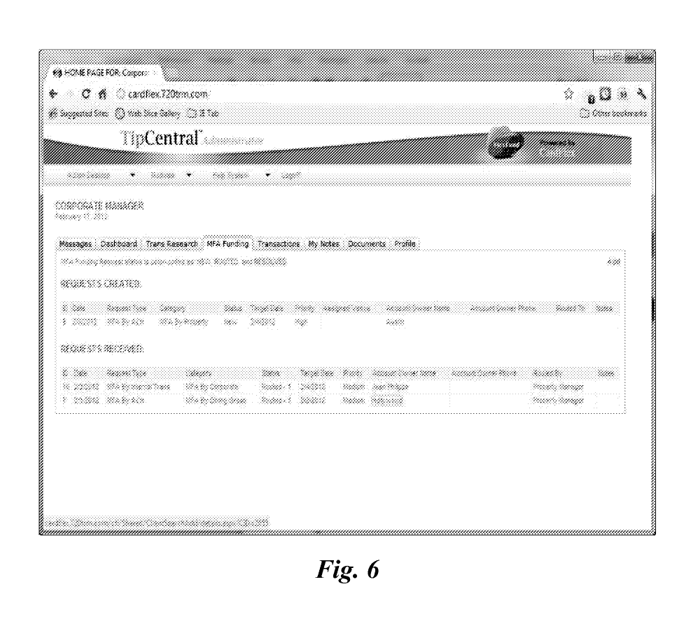

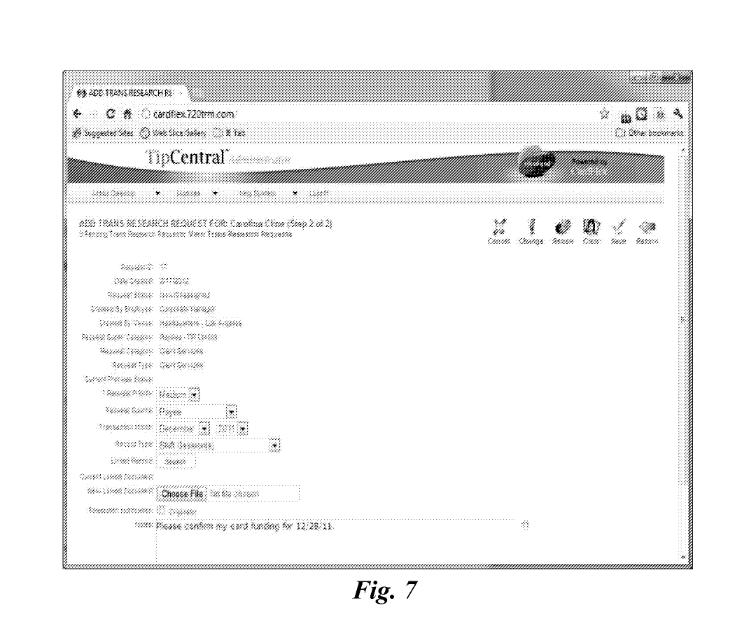

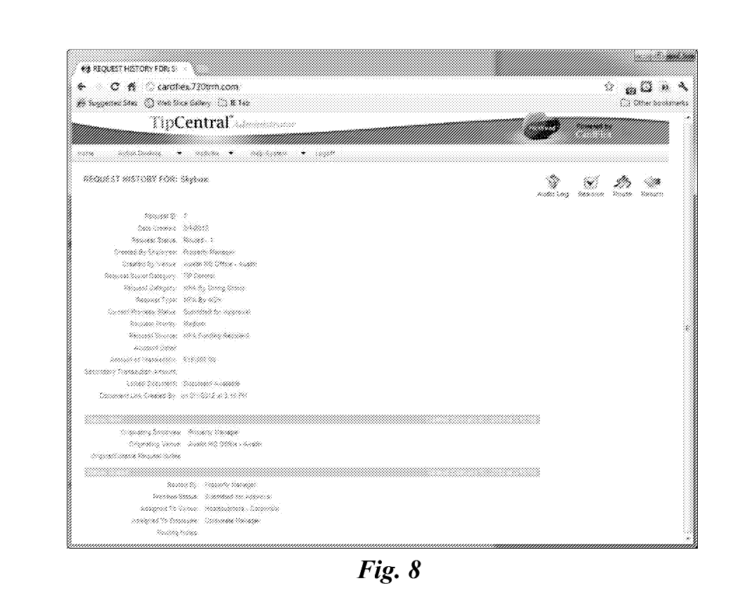

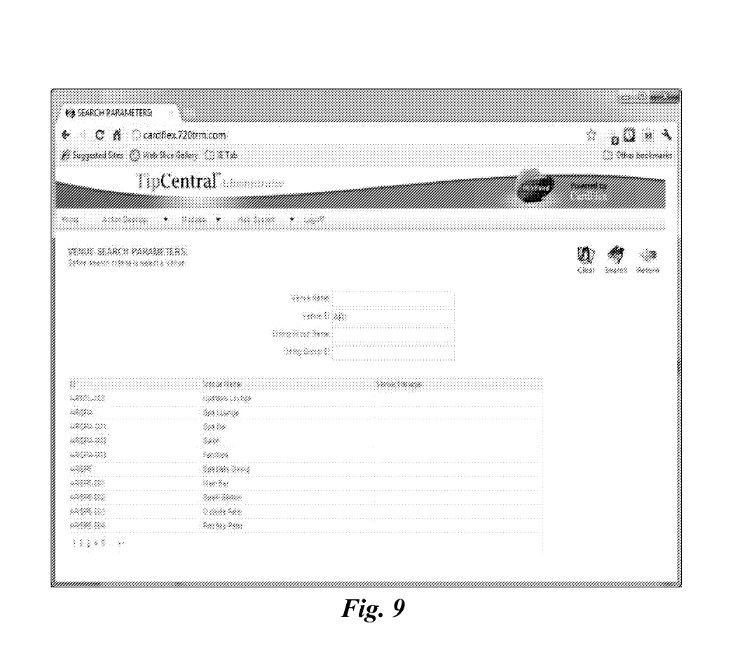

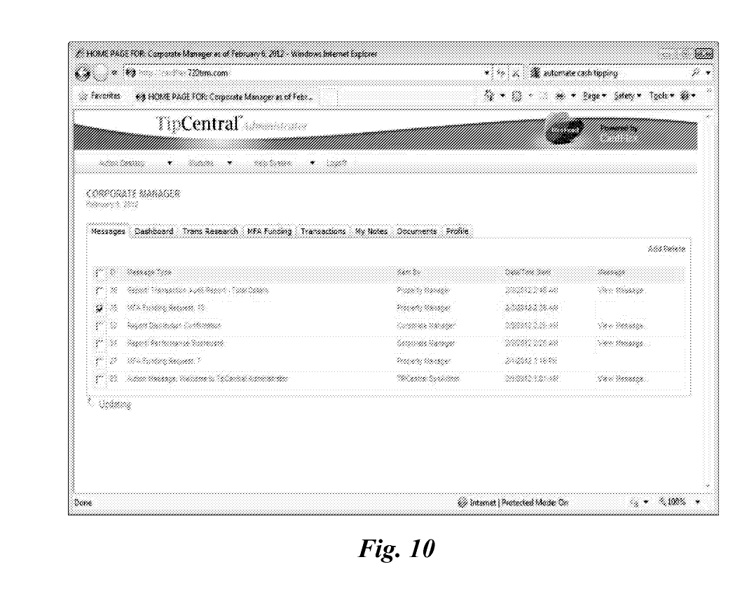

For embodiments of the invention that include the ability to instantly load funds to employee prepaid debit cards 5, the invention preferably includes functionality such as illustrated in FIGS. 3 and 4. Among other things, at the time that the tip payments are processed, the Master Tip Funding Account (MTFA) 35 (and/or the relevant Location/Property Tip Accounts 45) must have a sufficient balance to cover those payments. Preferably, the system includes reports that detail the current and/or remaining balance in the relevant MTFA 35 after every tip transaction. The system also includes an “intercept” that will not allow a transaction to be executed if there is NOT a sufficient balance in the MFA.

When the MTFA 35 needs to be funded, there are at least two ways to do this.
1. In certain embodiments, the apparatus and methods of the invention includes the ability for the venue/location 15 manager to use the software to submit an Automated Clearing House (ACH) or wire transfer request to have a selected amount of funds transferred from their General Business Account 40 (or other business bank account) to the MTFA 35 (see FIG. 3), preferably in an amount that is at least sufficient to cover the anticipated tip payments. Under this approach, the system can be setup to either:
a) Submit the ACH request for processing, or
b) Send it as a ticket request to the business's corporate office. Under this approach, to actually initiate the ACH transfer, a corporate user with sufficient privileges/authority must to enter the computer system and approve the request.
2. The relevant manager or other person within the business (such as the shift manager at the actual venue/restaurant involved) can select an option within the software to indicate that they will wire the funds directly to a third party who is functioning as the System/Processor 10 (see FIG. 1), for a “same day load” (meaning, the funds are expected to be paid out in tips later on the same day that the wire transfer is to occur). Preferably, this action by the shift manager (or other person) sends to the third party (System/Processor 10) an “instant” notice of some type (email, text, voice call, facsimile, etc.) that a wire transfer will be sent shortly to the account of the System/Processor 10. Once the System/Processor 10 has confirmed receipt of that wire transfer, the System/Processor 10 will complete the tip payment request, funding the MTFA 35.

The decision to fund the MTFA is made by the establishment. At set-up, rules-based funds monitoring can be set-up within the system itself, so that the balance is monitored to a selected trigger point, and a transfer is made into the MTFA based upon pre-determined parameters.

For certain embodiments such as those that use a third party System/Processor 10, the system can be implemented by steps such as the following:

Employer—Account Setup
Submit an application to the third party System/Processor 10
Choose a hardware option, such as:
   POS device(s) 20 onsite (at the restaurants, etc.)
   Online (via an Internet browser, such as logged into a site operated by the System/Processor 10)
Establish a Master Tip Funding Account (MTFA) 35
Link the business's bank account 40 to the MTFA 35, to enable transfers to replenish the MTFA when a replenish threshold is reached or a transfer is otherwise to be made
If desired, the business can set up an automated ACH payment/service from the linked account to fund the Master Funding Account 35 when the account balance reaches a selected/established replenishment threshold
Depending on installation requirements, the third party System/Processor 10 provides to the business either (a) the relevant hardware and/or (b) the links and login credentials for the online system (discussed further below)
Staff training

Employers—Disbursement Process
Each employee receiving tips (or sharing in a distribution of tips) is issued a prepaid debit card 5
Some or all of the prepaid debit cards 5 can be “Instant Issue.” Typically, prior to being issued to an employee, these cards should be kept in a secure manner at the business's location
For many businesses, the business's daily/nightly tip procedures can remain essentially the same as before they were using the invention, except:
   When ready to pay tips, the manager or other designated person logs into the system. For control and security, preferably this login requires using a unique and secure pass-code or other identification/security protocol
   For employees who are present with their prepaid debit cards 5, their record can be pulled up by the system by “swiping” their card
   As an alternative, and/or for employees who are not present when the manager is processing the tips, the manager can enter the employee ID number manually or select the employee from the dropdown menu
   The manager enters the amount of tips/money to be “loaded” onto that employee's prepaid debit card 5
   When the manager then hits “Enter” to confirm the tip amount, the employee's prepaid debit card 5 is immediately loaded with those tip funds
The system preferably maintains a transaction history for each tip disbursement, and that information can be reported as needed/required (for tax or other business uses). The reports can be generated and/or distributed automatically, and/or can be available via online access to persons with sufficient credentials)
The business's Master Tip Funding Account 35 balance preferably is updated and shown after each transaction, and the system can be customized to automatically send various balance alerts at selected balance thresholds (balance too high, balance too low, or both settings)
Online access to the MTFA 35 gives the business further ability to generate relevant reports, monitor the account's balance, and perform a variety of other functions Employees—Setup Process
When hiring a new employee (or for existing employees, when the invention is adopted by their employer), the employer issues to the employee a prepaid debit card
The employee activates that prepaid debit card, and registers the employee's account alert preferences (typically either email or text alerts). This can be accomplished in any suitable way, such as by logging onto a website designated by the third party System/Processor 10
Upon that registration by the employee, the third party System/Processor 10 preferably orders a personalized prepaid debit card 5 for the employee. This can be delivered to the employee in any suitable manner, such as by being sent to the employee's home address
After finishing a work shift, the employee preferably can either:
   Give that prepaid debit card 5 to the manager, for the manager to “tip out” the employee (swipe and thereby load the card with the appropriate tip amount), or
   Simply leave the location. Under this approach, the employee preferably receives the tip amount on their prepaid debit card 5 at whatever time the relevant tips are calculated and paid. With certain embodiments of the invention, one or more alerts by text message or email, for example, can be sent to the employee to advise that the money has been “loaded” onto their card, and even the amount loaded and new total balance on the card, if set-up and desired by the employee.
In certain embodiments, the employee can be given multiple options to access/use his earned tips:
   Leave the money on the debit card 5, and use it as a debit MasterCard/Visa/etc.
   Link the card to one of the employee's bank accounts. Among other things, this can enable the employee to transfer the tip money to that separate account from the employee's online “tip account” (the account set up by the employer, that reflects the actual balance on the employee's debit card at any given time)
   Write a paper check that draws upon that same “tip account”
   Withdraw the funds in cash, such as from an ATM, grocery store, Bank Teller, etc.
   Check the balance on their card/tip account such as by logging into an online site linked to that “tip account”
Preferably, the system includes online banking functionality for the employee's tip account, including access to a full suite of functionality and transaction history. Among other things, that online site for the employees/cardholders includes a custom “landing page” for each employee with a prepaid debit card, and can include one or more of the following or other features:
   An online activation portal, for both Instant Issue prepaid debit cards and personalized prepaid debit cards
   An activation process that includes verification of the card's CVV2 code, and includes funds transfer from any Instant Issue card to the employee's personalized prepaid debit card 5
   Other information related to the prepaid debit card 5, such as Terms & Conditions, Fee Schedule, Usage Tips, Access My Card, Lost/Stolen card reporting, and Email or other contact links to Customer Support

For embodiments of the invention in which the employer uses an online site for some or all of the relevant processing, preferably the site is setup with very little content, such as the items and functions detailed here:
The site is dedicated for ONLY loading prepaid debit cards 5
A secure user login is required (such as username and password), but is not necessarily required for separate transaction within a single logged-in session on the site
The relevant prepaid debit card number can be entered by any suitable means, including by “card reader” or by manual entry of the number or some relevant related code
The capability to issue credit/debit for a given employee ID, if the employee and/or the employee's card is not present (not with the user)
A Master Tip Funding Account 35 balance update after each transaction
Access to functions for reporting, funds transfer, etc.
Establish a low balance alert for Master Tip Funding Account 35

For the purpose of summarizing the invention, certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The apparatus and methods of the invention have been described with some particularity, but the specific designs, constructions, and steps disclosed are not to be taken as delimiting of the invention. A wide range of modifications and alternative structures and steps for practicing the invention will make themselves apparent to those of ordinary skill in the art, all of which will not depart from the essence of the invention, and all such changes and modifications are intended to be encompassed within the appended claims.

What is claimed is:

1. A method of administering and distributing tips received from customers, including:
a. providing a re-loadable debit card to a person who receives tips;
b. using the POS device to enter information regarding the tips received by that person;
c. periodically processing the information to determine what tip(s) have been earned by what person(s);
d. uploading that calculated tip amount to the person's debit card, bank account or other receptacle.

2. Apparatus for administering tips received from customers, including:
a. at least one computer, the computer being usable to enter information regarding tips received for at least one tip-receiver;
b. at least one re-loadable prepaid card or bank account in the control of that at least one tip-receiver;
c. a processing system to periodically receive and process information from the POS device to determine what tip(s) have been earned by that at least one tip-receiver;
d. means to upload to the prepaid card the calculated amount of tip earnings.

3. The method according to claim 1, wherein information regarding tips received is entered into the POS device by receipt of a customer's payment card information by the POS device.

4. The method according to claim 1, wherein information regarding tips received is entered into the computer by manual entry of the amount of cash tips received.

5. The method according to claim 1, wherein the calculated tip amount is uploaded to the debit card, bank account or other receptacle via an electronic banking system.

6. The method according to claim 1, wherein the POS device further includes a memory function for storing information regarding tips received.

7. The apparatus of claim 2, wherein information regarding tips received is entered into the computer by receipt of a customer's payment card information by the computer.

8. The apparatus of claim 2, wherein information regarding tips received is entered into the computer by manual entry of the amount of cash tips received.

9. The apparatus of claim 2, wherein the calculated amount of tip earnings are uploaded to the prepaid card or bank account via an electronic banking system.

10. The apparatus of claim 2, the computer further including a memory device for saving said information regarding tips received.
